(19) United States
(12) Patent Application Publication
(10) Pub. No.: US 2005/0059552 A1
(43) Pub. Date: Mar. 17, 2005

(54) Thermal receiver

(75) Inventors: Teh-Ming Kung, Rochester, NY (US); Paul D. Yacobucci, Rochester, NY (US); Brian T. Pope, Penfield, NY (US); Ronald S. King, Fairport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/729,567

(22) Filed: Dec. 5, 2003

Related U.S. Application Data
(63) Continuation-in-part of application No. 10/664,684, filed on Sep. 17, 2003, now abandoned.

(51) Int. Cl. B41M 5/38

(52) U.S. Cl. 503/227

(57) ABSTRACT

A receiver element for thermal dye transfer, a print assembly including the receiver element, and a method of printing are described wherein the receiver element includes a dye image-receiving layer and a stick preventative agent of the formula: 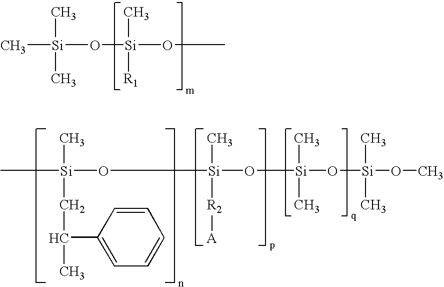
wherein R₁ is an alkyl chain of C₉H₁₉ or greater; R₂ is an alkyl chain of C₃H₆ or greater; A is NH—R₃, NHNH₂, NHCO—R₃, NH—R₄—NH₂, or NHCO—R₄—NH₂; R₃ is an alkyl chain of C₂H₅ or greater; R₄ is an alkyl chain of C₂H₄ or greater; m is from about 0 to 95 weight percent; n is from about 0 to about 70 weight percent; p is from 0 to about 40 weight percent; and q is from 0 to 95 weight percent, with the proviso that when m is 0, then n is 0, and R₃ is an alkyl chain of C₈H₁₇ or greater, otherwise when m is greater than 0, n is from 0.1 to 70 weight percent, based on the total weight of the stick preventative agent. The use of the stick preventative agent enables high-speed printing with reduced or no donor-receiver sticking.

### CROSS-REFERENCE TO RELATED APPLCATIONS

Reference is made to commonly assigned co-pending U.S. patent application Ser. No. 10/667,065 for “Thermal Donor for High Speed Printing,” and copending U.S. patent application Ser. No. 10/067,064 for “Thermal Printing Assembly” and its continuation-in-part application, U.S. patent application Ser. No. ______, all to David G. Foster et al.

### FIELD OF THE INVENTION

A thermal receiver element having reduced donor-receiver sticking, wherein the receiver element includes a stick preventative agent, is described, as well as the stick preventative agent, a print assembly including the receiver element, and a method of printing using the receiver element.

### BACKGROUND OF THE INVENTION

Thermal transfer systems have been developed to obtain prints from pictures that have been generated electronically, for example, from a color video camera or digital camera. An electronic picture can be subjected to color separation by color filters. The respective color-separated images can be converted into electrical signals. These signals can be operated on to produce cyan, magenta, and yellow electrical signals. These signals can be transmitted to a thermal printer. To obtain a print, a black, cyan, magenta, or yellow dye-donor layer, for example, can be placed face-to-face with a dye image-receiving layer of a receiver element to form a print assembly which can be inserted between a thermal printing head and a platen roller. A thermal print head can be used to apply heat from the back of the dye-donor sheet. The thermal print head can be heated up sequentially in response to the black, cyan, magenta, or yellow signals. The process can be repeated as needed to print all colors. A color hard copy corresponding to the original picture can be obtained. Further details of this process and an apparatus for carrying it out are contained in U.S. Pat. No. 4,621,271 to Brownstein.

A problem exists with many of the dye-donor elements and dye image-receiving elements used in thermal dye transfer systems. At the high temperatures used for thermal dye transfer, many polymers used in these elements can soften and adhere to each other, resulting in sticking and tearing of the elements upon separation. Areas of the dye-donor layer (other than the transferred dye) can adhere to the dye image-receiving element, rendering the receiving element useless.

To reduce donor-receiver sticking, it is known to add release agents to the dye-donor element or the receiver element. Use of silicone waxes and oils as lubricating elements are known in the art. For example, JP 04-255394 is directed to a recording method for high-speed printing wherein the coloring material layer of the transfer body and/or the image-receiving layer of the image-receiving body contains a siloxane-containing moisture-curing resin. However, moisture-curing resins can crosslink within the image-receiving layer, reducing dye diffusion and dye stability; can reduce coating uniformity; and can require additional processing steps. U.S. Pat. No. 5,356,859 to Lum et al. discloses the use of a dye image-receiving element including a polyoxyalkylene-modified dimethylsiloxane graft copolymer. However, the use of such material in high temperature extrusion coating of dye receiving layers is difficult because these materials degrade at high temperatures, resulting in unwanted reactions with other components of the dye-receiving layer. U.S. Pat. No. 4,839,338 to Marbrow discloses use of a receiver element coated with a release medium including two polysiloxanes which exhibit the same degradation and unwanted reactions as the materials in Lum. U.S. Pat. No. 4,643,917 to Koshizuka describes silicone waxes for use in heat-sensitive transfer recording media, but does not achieve good quality images. JP 61-262189 discloses the use of polyoxyalkylene silicone copolymers as a release material for use in heat sensitive recording materials, particularly where the polyoxyalkylene is grafted into the polysiloxane backbone for use in very high power printers. Release agents such as those listed above can affect the quality of the image printed on the dye image-receiving layer, and can be unsuitable for use in certain receiver elements, such as those prepared by extrusion coating of the dye image-receiving layer.

Various release agents have been found to exhibit decreased effectiveness when added to an extruded dye image-receiving layer. The release agents of the prior art can cause cross-linking and degradation of the extruded polymer mixture at the high temperatures used during extrusion, resulting in decreased image quality.

There is a need in the art for a means to reduce or eliminate donor-receiver sticking, while reducing amounts of additives in a receiver element, and while maintaining good print image formation. There is also a need to provide a receiver element having reduced donor-receiver sticking and providing good image quality wherein the dye image-receiving layer is extruded. Additives capable of reducing donor-receiver sticking and that are non-volatile and thermally stable are also desirable for use in extruded dye image-receiving layers.

### SUMMARY

A thermal receiver element comprising a dye image-receiving layer is described, wherein the receiver element includes a stick preventative agent of the formula: 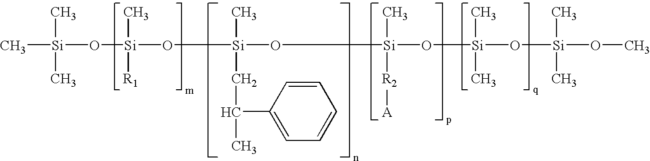
wherein R₁ is an alkyl chain of C₉H₁₉ or greater; R₂ is an alkyl chain of C₃H₆ or greater; A is NH—R₃, NHNH₂, NHCO—R₃, NH—R₄—NH₂, or NHCO—R₄—NH₂; R₃ is an alkyl chain of C₂H₅ or greater; R₄ is an alkyl chain of C₂H₄ or greater; m is from about 0 to 95 weight percent; n is from about 0 to about 70 weight percent; p is from 0 to about 40 weight percent; and q is from 0 to 95 weight percent, with the proviso that when m is 0, then n is 0, and R₃ is an alkyl chain of C₈H₁₇ or greater, otherwise when m is greater than 0, n is from 0.1 to 70 weight percent, based on the total weight of the stick preventative agent.

A print assembly including a dye-donor element and a receiver element are described, wherein the receiver element includes a stick preventative agent. A method of forming an image using the print assembly is also described.

Use of the receiver element having the stick preventative agent described herein aids in reducing or preventing sticking between the dye-donor element and the receiver element during printing, and provides good image quality.

### DETAILED DESCRIPTION

According to various embodiments, a receiver element having a dye image-receiving layer and a stick preventative agent can reduce or eliminate donor-receiver sticking. As used herein throughout, “sticking” refers to adherence of a dye-donor element to a receiver element. Sticking can be detected by resultant defects in the dye-donor element or receiver element. For example, sticking can cause a removal of dye from the dye-donor element, appearing as a clear spot on the dye-donor element, or an over-abundance of dye on the receiver element. Sticking also can cause an uneven or spotty appearance on the dye-donor element. “Gross sticking” is when the dye-donor layer of the dye-donor element is pulled off of the support layer and sticks to the receiver element. This can appear as uneven and randomized spots across the dye-donor element and receiver element. “Microsticking” results in an undesirable image where a small area of the dye-donor element and receiver element stick together. Microsticking can be observed with a magnifying glass or microscope.

A stick preventative agent for addition to a thermal receiver element can reduce or eliminate donor-receiver sticking during printing. The stick preventative agent can be a siloxane polymer, comprising a polymeric backbone of alternating silicon and oxygen atoms. The terms “siloxane-containing polymer,” “siloxane-based polymer,” and “siloxane polymer” are herein used synonymously and mean that the polymer can be a copolymer, block copolymer, or graft polymer, wherein the polymer has non-siloxane polymer chains, and is of the formula: 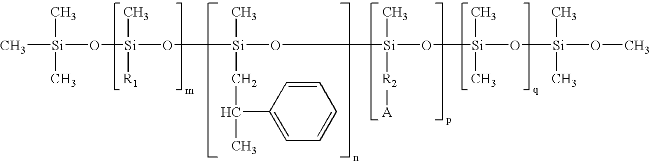
wherein R₁ is an alkyl chain of C₉H₁₉ or greater; R₂ is an alkyl chain of C₃H₆ or greater; A is NH—R₃, NHNH₂, NHCO—R₃, NH—R₄—NH₂, or NHCO—R₄—NH₂; R₃ is an alkyl chain of C₂H₅ or greater; R₄ is an alkyl chain of C₂H₄ or greater; m is from about 0 to 95 weight percent; n is from about 0 to about 70 weight percent; p is from 0 to about 40 weight percent; and q is from 0 to 95 weight percent, with the proviso that when m is 0, then n is 0, otherwise when m is greater than 0, n is from 0.1 to 70 weight percent, based on the total weight of the stick preventative agent. According to various embodiments, m can be from about 20 to 80 weight percent, n can be from about 1 to about 80 weight percent, more preferably from about 20 to about 80 weight percent, and p can be from 20 to about 40 weight percent when n and m are both 0, or any combination thereof. R₁, R₂, R₃ and R₄ can each independently be selected from straight or branched alkyl chains, except that when m and n are both 0, R₃ is an alkyl chain of C₈H₁₇ or greater.

The stick preventative agent can be present in the receiver element in an amount of greater than or equal to about 5.5×10⁻⁴ g/m². For example, the stick preventative agent can be present in an amount of greater than or equal to about 0.001 g/m², from about 5.5×10⁻⁴ g/m² to about 0.045 g/m², from about 5.5×10⁻⁴ g/m² to about 0.02 g/m², or from about 0.001 g/m² to about 0.01 g/m².

The stick preventative agent can be present in one or more layers of the receiver element. For example, the stick preventative agent can be present in the dye image-receiving layer, a support, an adhesive layer, a tie-layer, an antistatic layer, or any other layer of the receiver element. When the support is a composite or laminate structure, the stick preventative agent can be in one or more layers of the support, for example, a base layer, a tie-layer, an adhesive layer, or a backing layer. According to various embodiments, the stick preventative agent can be in a layer between the base layer of the support and the dye image-receiving layer.

The support for the receiver element can be a transparent film, for example, a poly(ether sulfone), a polyimide, a cellulose ester such as cellulose acetate, a poly(vinyl alcohol-co-acetal), or a poly(ethylene terephthalate). The support can be a reflective layer, for example, baryta-coated paper, white polyester (polyester with white pigment incorporated therein), an ivory paper, a condenser paper, or a synthetic paper, for example, DuPont Tyvek® by E.I. DuPont de Nemours and Company. The support can be employed at any desired thickness, for example, from about 10 μm to 1000 μm. Exemplary supports for the dye image-receiving layer are disclosed in commonly assigned U.S. Pat. Nos. 5,244,861 and 5,928,990, and in EP-A-0671281. Other suitable supports as known to practitioners in the art can also be used.

According to various embodiments, the support can be a composite or laminate structure comprising a base layer and one or more additional layers. The additional layers can include a tie-layer, an adhesive layer, an antistatic layer, a backing layer, a slip layer, or a combination thereof. The base layer can comprise more than one material, for example, a combination of one or more of a microvoided layer, a nonvoided layer, a synthetic paper, a natural paper, and a polymer.

The dye image-receiving layer can comprise a polymeric material chosen for its compatibility and receptivity for the dyes to be transferred from a dye-donor element. During printing, a dye can migrate rapidly from a dye-donor layer into the dye image-receiving layer during the dye transfer step. The dye image-receiving layer composition can immobilize the dye and stabilize the dye in an intended viewing environment.

The dye image-receiving layer can include a thermoplastic material, for example, a polyester, a polyolefin, a polycarbonate, a vinyl polymer, a polyurethane, a polyvinyl chloride, a poly(styrene-coacrylonitrile), a poly(caprolactone), or combinations thereof, such as blends or copolymers.

Polyester-polycarbonate blends suitable for the dye image-receiving layer can include unmodified bisphenol-A polycarbonates having a number molecular weight of at least about 25,000, such as those disclosed in U.S. Pat. No. 4,695,286. Specific examples include MAKROLON 5700 (Bayer AG) and LEXAN 141 (General Electric Co.) polycarbonates.

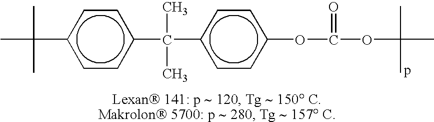

For polyester-polycarbonate blends, the polycarbonate can have a Tg of from about 100° C. to about 200° C., and the polyester can have a lower Tg than the polycarbonate. The Tg of the final polyester-polycarbonate blend can be between 40° C. and 100° C. Higher Tg polyester and polycarbonate polymers also can be useful.

According to various embodiments, the dye image-receiving layer can include a polyester having recurring dibasic acid derived units and diol derived units. A portion of the dibasic acid derived units, for example, at least about 50 mole %, can include dicarboxylic acid derived units having an alicyclic ring within two carbon atoms of each carboxyl group of the corresponding dicarboxylic acid. A portion of the diol derived units, for example, at least about 30 mole %, can have an aromatic ring not immediately adjacent to each hydroxyl group of the corresponding diol, or an alicyclic ring. Examples of such polyesters suitable for dye image-receiving layers include polyesters such as those found in U.S. Pat. No. 5,387,571.

In the case of an extrudable polyester, monomers (as a replacement for either a diacid and/or diol that has three or more functional groups, preferably one more multifunctional polyols or polyacids, and derivatives thereof) that can provide branching can be used, for example, multifunctional polyols, including but not limited to, glycerin, 1,1,1-trimethylolethane, 1,1,1-trimethylolpropane, and combinations thereof. Polyacids having more than two carboxylic acid groups (including esters or anhydrides derivatives thereof) include, for example, trimellitic acid, trimesic acid, 1,2,5-, 2,3,6- or 1,8,4-naphthalene tricarboxylic anhydride, 3,4,4′-diphenyltricarboxylic anhydride, 3,4,4′-diphenylmethanetricarboxylic anhydride, 3,4,4′-diphenylethertricarboxylic anhydride, 3,4,4′-benzophenonetricarboxylic anhydride acid, and derivatives thereof. Multifunctional polyols or anhydrides, for example, include compounds represented by the following structures: 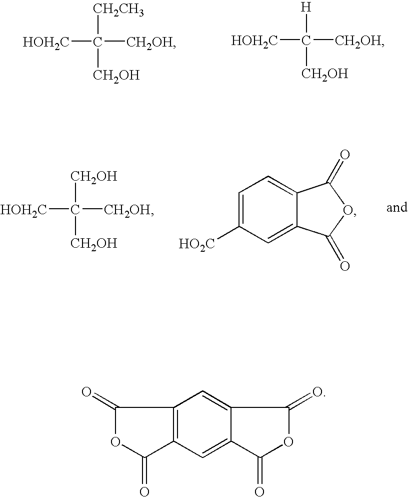
Examples of such extrudable branched polyesters include, for example, 1,4-cyclohexanedicarboxylic acid, 1,4-cyclohexanedimethanol, 4,4′-bis(2-hydroxyethyl)bisphenol-A, and 2-ethyl-2-(hydroxymethyl)-1,3-propanediol.

Various polymerization catalysts known to practitioners in the art can be used to make the polymers, for example, polyesters, for the dye-image receiving layer. For example, a catalyst can be added in the amount of from about 0.01% to about 0.08% by weight solids to the polymer composition of the dye image-receiving layer to prevent or minimize transesterification.

A plasticizer can be present in the dye image-receiving layer in any effective amount. For example, the plasticizer can be present in an amount of from about 5% to about 100%, or from about 4% to about 30%, based on the weight of the polymer in the dye-image receiving layer. According to various embodiments, an aliphatic ester plasticizer can be used in the dye-image receiving layer. Suitable aliphatic ester plasticizers can include both monomeric esters and polymeric esters. Examples of aliphatic monomeric esters include ditridecyl phthalate, dicyclohexyl phthalate, and dioctylsebacate. Examples of aliphatic polyesters include polycaprolactone, poly(butylene adipate) and poly(hexamethylene sebacate). Various aliphatic ester plasticizer, including polyesters or monomeric esters, are disclosed in U.S. Pat. No. 6,291,396. Phthalate ester plasticizers are disclosed in U.S. Pat. No. 4,871,715.

The dye image-receiving layer can be formed on the support by any method known to practitioners in the art, including but not limited to printing, solution coating, dip coating, and extrusion coating. If the dye image-receiving layer is made by extrusion coating, and the layer includes the stick preventative agent, the stick preventative agent is of the formula wherein p is 0. Wherein the dye image-receiving layer is extruded, the process can include (a) forming a melt comprising a thermoplastic material; (b) extruding or coextruding the melt as a single-layer film or a layer of a composite (multilayer or laminate) film; and (c) applying the extruded film to the support for the receiver element. In step (b), the melt can be extruded and cast as a film or laminate film at a thickness of at least 100 microns, for example, 100 to 800 microns, and then uniaxially or biaxially stretched to less than 10 microns, for example, 3-4 microns. The extruded uniaxially or biaxially stretched film can be applied to the support, for example, a moving web. Examples of suitable extruded dye image-receiving layers include those disclosed in U.S. Pat. Nos. 5,387,571 and 5,302,574. According to various embodiments, a tie-layer can be used for adhering the extruded dye-receiving layer to the support.

When the dye image-receiving layer is made by high temperature melt extrusion, a phosphorous-containing stabilizer can be added to the dye image-receiving layer to prevent degradation of the polyester polymer blend during extrusion. The phosphorous-containing stabilizer can be a phosphorous acid, an organic diphosphite such as bis(2-ethylhexyl)phosphite, a phosphate, an alkyl phosphate, an aryl phosphate, an inorganic phosphate, a phosphoric acid ester, or a phosphorous acid. The phosphorous stabilizer can be combined with a plasticizer such as dioctyl sebacate or the like. To improve compatibility, the plasticizer can be combined with the stabilizer prior to combining both with other components of the dye image-receiving layer.

The dye image-receiving layer can be present in an amount which is effective for its intended purpose. For example, the dye image-receiving layer can be in a concentration of from about 0.5 g/m² to about 20 g/m², 1.0 g/m² to 15 g/m², or 3.0 g/m² to 10 g/m². The dye image-receiving layer can be present on one or both sides of the support.

According to various embodiments, the receiver element can include a tie-layer between the support and the dye image-receiving layer. The tie-layer can be a conventional material capable of adhering the support and dye image-receiving layer together. The tie-layer can comprise a thermoplastic polymer having preselected antistatic properties, adhesive properties, or viscoelastic properties.

According to various embodiments, the tie-layer can have viscoelastic properties such that the viscosity is not more than 10 times or less than 1/1 0, or not more than 3 times or less than ⅓, that of the dye-image receiving layer.

According to various embodiments, the tie-layer can have antistatic properties. Suitable materials for use as the antistatic tie-layer include PELLESTAT 300 polymer, commercially available from Sanyo Chemical Industries, Ltd. (Tokyo) or Tomen America, Inc. (New York, N.Y.), PEBAX copolymer, commercially available from Atofina (Finland), polymers disclosed in EP-A-1,167,425, and other polymers as known to practitioners in the art.

Other materials known in the art that can be melt processed while retaining their antistatic activity and overall physical performance are various polymeric substances containing a high concentration of polyether blocks. Ionic conduction along the polyether chains can make these polymers inherently dissipative. Exemplary ionic conductors can include polyether-block-copolyamide (U.S. Pat. Nos. 4,115,475; 4,195,015; 4,331,786; 4,839,441; 4,864,014; 4,230,838; 4,332,920; and 5,840,807), polyetheresteramide (U.S. Pat. Nos. 5,604,284; 5,652,326; 5,886,098), and a thermoplastic polyurethane containing a polyalkylene glycol moiety (U.S. Pat. Nos. 5,159,053 and 5,863,466). Such inherently dissipative polymers (IDPs) have been shown to be thermally stable and readily processable in the melt state in their neat form, or in blends with other thermoplastic materials. Other known inherently conductive polymers (ICPs), for example, polyaniline, polypyrrole, and polythiophene, can be sufficiently thermally stable if a compatibilizer is added.

According to various embodiments, the antistatic tie-layer and the dye-image receiving layer can be coextruded. For example, a first melt and a second melt can be formed, wherein the first melt comprises a polymer for the dye image-receiving layer and the second melt comprises the thermoplastic antistatic polymer having desirable adhesive and viscoelastic properties. The coextruded layers, or composite film, can be stretched to reduce the thickness. The extruded and stretched film can be applied to a support of the receiver element at a temperature below the Tg of the dye image-receiving layer. According to various embodiments, this can be done by quenching the extruded film between two nip rollers.

According to various embodiments wherein the tie-layer and dye image-receiving layer are coextruded, a compatibilizer layer can be added to ensure compability between the layers by controlling phase separation. Exemplary compatibilizers can include those described in U.S. Pat. No. 6,436,619, EP-A-0,342,066, and EP-A-0,218,665. Further examples of compatibilizers can include, but are not limited to: polyethylene, polypropylene, ethylene/propylene copolymers, ethylene/butene copolymers, grafts of the above with maleic anhydride or glycidyl methacrylate; ethylene/alkyl (meth)acrylate/maleic anhydride copolymers, the maleic anhydride being grafted or copolymerized; ethylene/vinyl acetate/maleic anhydride copolymers, the maleic anhydride being grafted or copolymerized; the two above copolymers in which anhydride is replaced fully or partly by glycidyl methacrylate; ethylene/(meth)acrylic acid copolymers and their salts; ethylene/alkyl (meth)acrylate/glycidyl methacrylate copolymers, the glycidyl methacrylate being grafted or copolymerized; and grafted copolymers constituted by at least one mono-amino oligomer of polyamide and of an alpha-mono-olefin (co)polymer grafted with a monomer able to react with the amino functions of said oligomer. Other exemplary compatibilizers can include terpolymers of ethylene/methyl acrylate/glycidyl methacrylate and copolymers of ethylene/glycidyl methacrylate, commercially available as LOTADER from Atofina, or maleic anhydride grafted or copolymerized polyolefins such as polypropylene, or polyethylene, commercially available as OREVAC from Atofina.

The dye image-receiving layer, or an overcoat layer thereon, additionally can include a release agent as is conventional in the art. Various exemplary release agents are disclosed, for example, in U.S. Pat. Nos. 4,820,687 and 4,695,286, and can include, for example, Silwet L-7230 and Silwet L-7001 from Crompton Corporation of Long Reach, W. Va., USA; and solid polydimethylsiloxanes such as but not limited to MB50-315 silicone, a 50:50 blend of bisphenol-A polycarbonate and ultrahigh MW polydimethyl siloxane, from Dow Corning of Midland, Mich., USA.

The dye-donor element suitable for use with the receiver element described herein can include a dye-donor layer. The dye-donor layer can include one or more colored areas (patches) containing dyes suitable for thermal printing. As used herein, a “dye” can be one or more dye, pigment, colorant, or a combination thereof, and can optionally be in a binder or carrier as known to practitioners in the art. During thermal printing, at least a portion of one or more colored areas can be transferred to the receiver element, forming a colored image on the receiver element. The dye-donor layer can include a laminate area (patch) having no dye. The laminate area can follow one or more colored areas. During thermal printing, the entire laminate area can be transferred to the receiver element. The dye-donor layer can include one or more colored areas and one or more laminate areas. For example, the dye-donor layer can include three color patches, for example, yellow, magenta, and cyan, and a clear laminate patch, for forming a three color image with a protective laminate layer on a receiver element.

Any dye transferable by heat can be used in the dye-donor layer of the dye-donor element. For example, sublimable dyes can be used, such as but not limited to anthraquinone dyes, such as Sumikalon Violet RS® (product of Sumitomo Chemical Co., Ltd.), Dianix Fast Violet 3R-FS® (product of Mitsubishi Chemical Corporation.), and Kayalon Polyol Brilliant Blue N-BGM® and KST Black 146® (products of Nippon Kayaku Co., Ltd.); azo dyes such as Kayalon Polyol Brilliant Blue BM®, Kayalon Polyol Dark Blue 2BM®, and KST Black KR® (products of Nippon Kayaku Co., Ltd.), Sumickaron Diazo Black 5G® (product of Sumitomo Chemical Co., Ltd.), and Miktazol Black 5 GH® (product of Mitsui Toatsu Chemicals, Inc.); direct dyes such as Direct Dark Green B® (product of Mitsubishi Chemical Corporation) and Direct Brown M® and Direct Fast Black D® (products of Nippon Kayaku Co. Ltd.); acid dyes such as Kayanol Milling Cyanine 5R® (product of Nippon Kayaku Co. Ltd.); and basic dyes such as Sumicacryl Blue 6G® (product of Sumitomo Chemical Co., Ltd.), and Aizen Malachite Green® (product of Hodogaya Chemical Co., Ltd.); magenta dyes of the structures 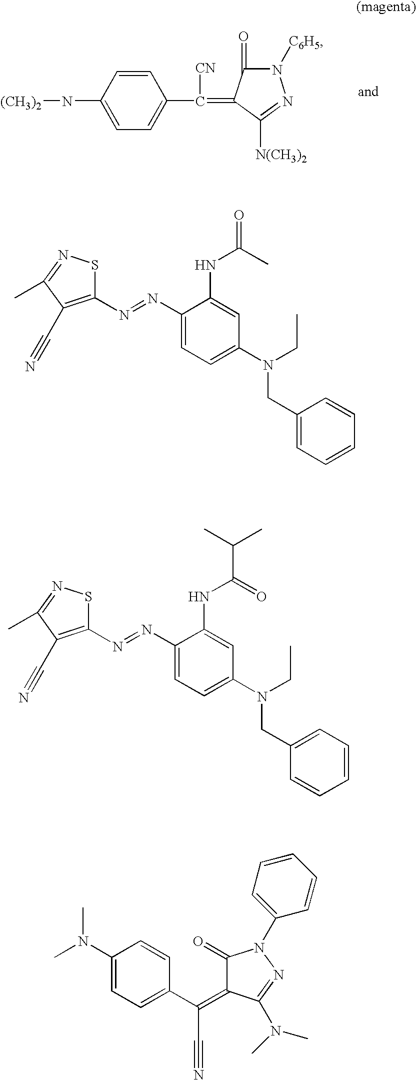
cyan dyes of the structures 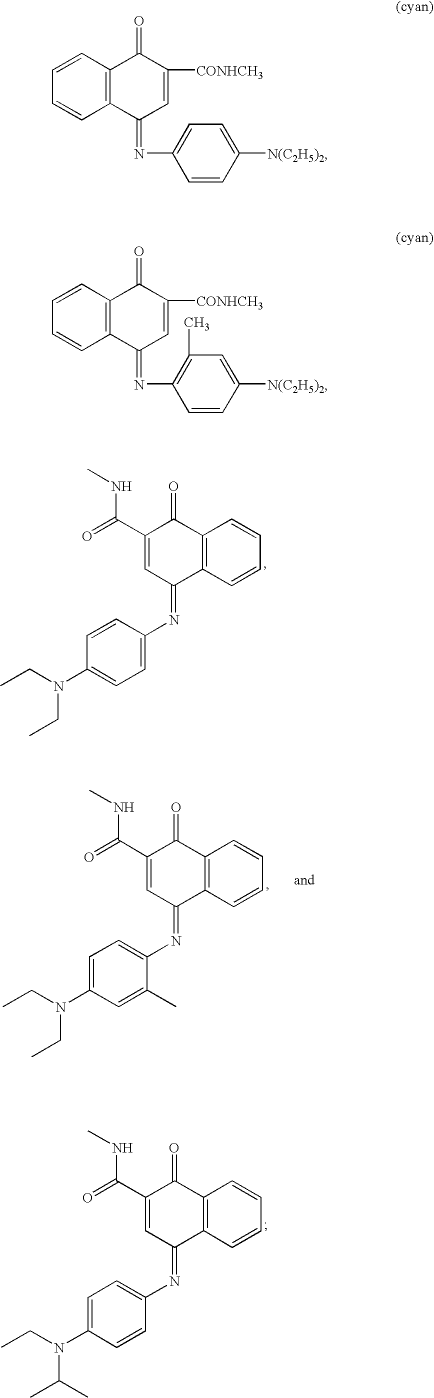
and yellow dyes of the structures 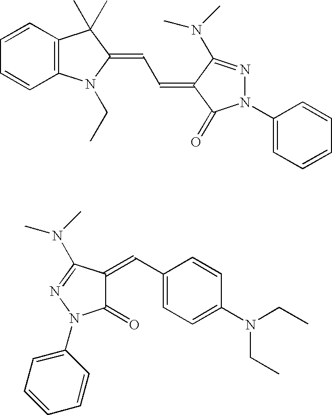
Other examples of dyes are set forth in U.S. Pat. No. 4,541,830, and are known to practitioners in the art. The dyes can be employed singly or in combination to obtain a monochrome dye-donor layer. The dyes can be used in an amount of from about 0.05 to about 1 g/m² of coverage. According to various embodiments, the dyes can be hydrophobic.

To form the dye-donor layer, one or more dyes can be dispersed in a polymeric binder, for example, a polycarbonate; a poly(styrene-co-acrylonitrile); a poly(sulfone); a poly(phenylene oxide); a cellulose derivative such as but not limited to cellulose acetate hydrogen phthalate, cellulose acetate, cellulose acetate propionate, cellulose acetate butyrate, or cellulose triacetate; or a combination thereof. The binder can be used in an amount of from about 0.1 g/m² to about 5 g/m².

The dye-donor layer can be formed or coated on a support. The dye-donor layer can be formed on the support by a printing technique such as but not limited to a gravure process, spin-coating, solvent-coating, extrusion coating, or other methods known to practitioners in the art.

The support can be formed of any material capable of withstanding the heat of thermal printing. According to various embodiments, the support can be dimensionally stable during printing. Suitable materials can include polyesters, for example, poly(ethylene terephthalate); polyamides; polycarbonates; glassine paper; condenser paper; cellulose esters, for example, cellulose acetate; fluorine polymers, for example, polyvinylidene fluoride, and poly(tetrafluoroethylene-cohexafluoropropylene); polyethers, for example, polyoxymethylene; polyacetals; polyolefins, for example, polystyrene, polyethylene, polypropylene, and methylpentane polymers; polyimides, for example, polyimide-amides and polyether-imides; and combinations thereof. The support can have a thickness of from about 2 μm to about 30 μm, for example, from about 3 μm to about 7 μm.

According to various embodiments, a subbing layer, for example, an adhesive or tie layer, a dye-barrier layer, or a combination thereof, can be coated between the support and the dye-donor layer. The adhesive or tie layer can adhere the dye-donor layer to the support. Suitable adhesives are known to practitioners in the art, for example, Tyzor TBT® from E.I. DuPont de Neumours and Company. The dye-barrier layer can include a hydrophilic polymer. The dye-barrier layer can provide improved dye transfer densities.

The dye-donor element can also include a slip layer capable of preventing the print head from sticking to the dye-donor element. The slip layer can be coated on a side of the support opposite the dye-donor layer. The slip layer can include a lubricating material, for example, a surface-active agent, a liquid lubricant, a solid lubricant, or mixtures thereof, with or without a polymeric binder. Suitable lubricating materials can include oils or semi-crystalline organic solids that melt below 100° C., for example, poly(vinyl stearate), beeswax, perfluorinated alkyl ester polyether, poly(caprolactone), carbowax, polyethylene homopolymer, or poly(ethylene glycol). Suitable polymeric binders for the slip layer can include poly(vinyl alcohol-co-butyral), poly(vinyl alcohol-co-acetal), poly(styrene), poly(vinyl acetate), cellulose acetate butyrate, cellulose acetate, ethyl cellulose, and other binders as known to practitioners in the art. The amount of lubricating material used in the slip layer is dependent, at least in part, upon the type of lubricating material, but can be in the range of from about 0.001 to about 2 g/m², although less or more lubricating material can be used as needed. If a polymeric binder is used, the lubricating material can be present in a range of 0.1 to 50 weight %, preferably 0.5 to 40 weight %, of the polymeric binder.

The dye-donor element can include a release agent, a stick preventative agent, or a combination thereof in one or more layers to aid in reducing donor-receiver sticking. Release agents as known to practitioners in the art can be added for example, to the dye-donor layer, the slip layer, or both. Suitable release agents include those described in U.S. Pat. Nos. 4,740,496 and 5,763,358. Suitable stick preventative agents are set forth in co-pending U.S. patent application Ser. No. 10/667,065 for “Thermal Donor for High Speed Printing,” and copending U.S. patent application Ser. No. 10/067,064 for “Thermal Printing Assembly” and its continuation-in-part application, U.S. patent application Ser. No. ______, all to David G. Foster et al. According to various embodiments, the dye-donor element can include the same stick preventative agent as the receiver element.

The dye-donor element can be a sheet of one or more colored patches or laminate, or a continuous roll or ribbon. The continuous roll or ribbon can include one patch of a monochromatic color or laminate, or can have alternating areas of different patches, for example, one or more dye patches of cyan, magenta, yellow, or black, one or more laminate patches, or a combination thereof.

The dye-donor element and receiver element described herein, when placed in superimposed relationship such that the dye-donor layer of the dye-donor element is adjacent the dye image-receiving layer of the receiver element, can form a print assembly. An image can be formed by passing the print assembly past a print head, wherein the print head is located on the side of the dye-donor element opposite the receiver element. The print head can apply heat image-wise to the dye-donor element, causing the dyes in the dye-donor layer to transfer to the dye image-receiving layer of the receiver element. Thermal print heads that can be used with the print assembly are available commercially and known to practitioners in the art. Exemplary thermal print heads can include, but are not limited to, a Fujitsu Thermal Head (FTP-040 MCSOO1), a TDK Thermal Head F415 HH7-1089, and a Rohm Thermal Head KE 2008-F3.

When multiple color images are to be obtained, the print assembly is formed as many times as there are colors to be printed during the time when heat is applied by the thermal print head. After the first dye is transferred from a first dye-donor element, the dye-donor element and receiver element can be peeled apart. A second dye-donor element (or another area of the dye-donor element with a different dye) can be brought into register with the receiver element and the process can be repeated until all colors are printed. A laminate patch can also be printed on the image in this manner to protect the image.

An improved receiver element including a stick preventative agent as described herein provides reduced donor-receiver sticking with a smaller quantity of stick preventative agent, and provides a good quality image when used in a print assembly with a dye-donor element, for example, an image with a print density greater than or equal to 1.5, for example, 2.0.

The following examples are provided to further illustrate the invention.

### EXAMPLES

Throughout the following examples, PES designates a polyester derived from 1,4-cyclohexanedicarboxylic acid, 1,4-cyclohexanedimethanol, 4,4′-bis(2-hydroxyethyl)bisphenol-A, and 2-ethyl-2-(hydroxymethyl)-1,3-propanediol; PC designates bisphenol A polycarbonate, known as GE Lexan 151, obtained from General Electric Co; and DOS designates dioctyl sebacate.

### Example 1

### Solvent-Coated Dye Image-Receiving Layer

Thermal receiver elements were prepared using the dye image-receiving layer compositions shown in Table 1, and the following procedures.

Receiver Element:

Each of the receiver elements was prepared by first extrusion laminating a paper core with a 36 μm thick microvoided composite film (OPPalyte 350 KI 8, ExxonMobil). The composite film side of the resulting laminate was prepared as follow:
(1) A subbing layer of a mixture of amino functionalized silane coupling agents of PCR Prosil 221(0.055 g/m²) and Prosil 2210(0.055 g/m²) (from PCR of Gainesville, Fla.), and lithium chloride(0.003 g/m²) coated from 3A alcohol (a mixture of 5% by volume of methanol and 95% by volume of ethanol), was coated on the composite film.
(2) A dye-receiving layer of the composition described in Table 1 was coated on top of the prepared subbing layer at a coating speed of 7.6 meters per minute and in-line drying at 190° F. for approximately 5 minutes.

A backing layer (MLT-70, Exxon-Mobil Co.) was extrusion laminated to a side of the paper core opposite to the microvoided composite film.

TABLE 1

| | | | Additive | PES | PC | DOS |
|---|---|---|---|---|---|---|
| Sample | Additive | Additive Description | g/m² | g/m² | g/m² | g/m² |
| C-1 | none | — | 0 | 2.71 | 0.726 | 0.194 |
| C-2 | Gelest DMS S-12 | PDMS | 0.022 | 2.71 | 0.726 | 0.194 |
| C-3 | Gelest DMS S-21 | PDMS | 0.022 | 2.71 | 0.726 | 0.194 |
| C-4 | GP-10-100 | PDMS | 0.022 | 2.71 | 0.726 | 0.194 |
| C-5 | GP-10-350 | PDMS | 0.022 | 2.71 | 0.726 | 0.194 |
| C-6 | GP-10-1000 | PDMS | 0.022 | 2.71 | 0.726 | 0.194 |
| C-7 | GP-10-10,000 | PDMS | 0.044 | 2.71 | 0.726 | 0.194 |
| C-8 | GP-360 | methyloctyl silicone | 0.044 | 2.675 | 0.717 | 0.194 |
| C-9 | GP-368 | methyloctyl silicone | 0.044 | 2.675 | 0.717 | 0.194 |
| C-10 | PECOSIL FSL-150 | fluorinated silicone | 0.11 | 2.71 | 0.726 | 0.194 |
| C-11 | PECOSIL FSL-300 | fluorinated silicone | 0.11 | 2.71 | 0.726 | 0.194 |
| C-12 | PECOSIL FSH-150 | fluorinated silicone | 0.11 | 2.71 | 0.726 | 0.194 |
| C-13 | Silwet L-7230 | dimethyl siloxane with | 0.001 | 2.71 | 0.726 | 0.194 |
| | | alkoxylene oxide side | | | | |
| | | chain | | | | |
| C-14 | Silwet L-7230 | dimethyl siloxane with | 0.002 | 2.71 | 0.726 | 0.194 |
| | | alkoxylene oxide side | | | | |
| | | chain | | | | |
| C-15 | Silwet L-7230 | dimethyl siloxane with | 0.011 | 2.71 | 0.726 | 0.194 |
| | | alkoxylene oxide side | | | | |
| | | chain | | | | |
| E-1 | GP-7101 | dimethyl silicone with | 0.044 | 2.71 | 0.726 | 0.194 |
| | | organic wax side chain | | | | |
| E-2 | GP-7101 | dimethyl silicone with | 0.022 | 2.71 | 0.726 | 0.194 |
| | | organic wax side chain | | | | |
| E-3 | GP-7105 | dimethyl silicone with | 0.044 | 2.675 | 0.717 | 0.194 |
| | | amine functionalized | | | | |
| | | organic wax side chain | | | | |
| E-4 | GP-70S | methylalkylaryl silicone | 0.022 | 2.71 | 0.726 | 0.194 |
| E-5 | GP-70S | methylalkylaryl silicone | 0.011 | 2.71 | 0.726 | 0.194 |
| E-6 | GP-70S | methylalkylaryl silicone | 0.004 | 2.71 | 0.726 | 0.194 |
| E-7 | GP-70S | methylalkylaryl silicone | 0.001 | 2.71 | 0.726 | 0.194 |
| E-8 | GP-74 | methylalkylaryl silicone | 0.004 | 2.71 | 0.726 | 0.194 |
| E-9 | GP-74 | methylalkylaryl silicone | 0.001 | 2.71 | 0.726 | 0.194 |
| E-10 | GP-154 | methylalkyl silicone | 0.011 | 2.71 | 0.726 | 0.194 |
| E-11 | GP-154 | methylalkyl silicone | 0.001 | 2.71 | 0.726 | 0.194 |

Dye-Donor Element:

The dye-donor element was prepared by coating sequential areas of cyan, magenta, and yellow dye in the order recited on 4.5 micron poly(ethylene terephthalate) support. The dye side was prepared by first coating a subbing layer of a titanium alkoxide (DuPont Tyzor TBT®) (0.12 g/m²) from n-propyl acetate and n-butyl alcohol solvent mixture.

The cyan dye patch contained cyan dye #1 at 0.086 g/m², cyan dye #2 at 0.08 g/m², and cyan dye #3 at 0.2 g/m², cellulose acetate propionate binder at 0.21 g/m², polyester sebacate (Paraplex G-25) at 0.015 g/m², and divinyl benzene beads at 0.008 g/m², coated from a solvent mixture containing 70% toluene, 20% methanol, and 5% cyclopentanone.

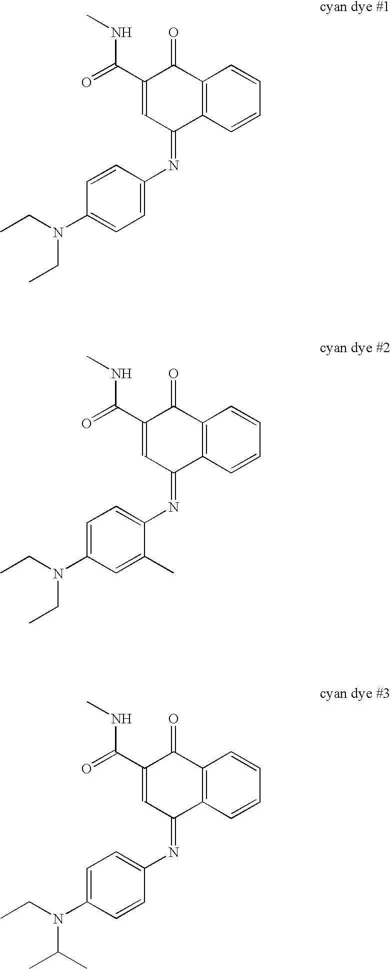

The yellow dye donor patch contained yellow dye #1 at 0.067 g/m², yellow dye #2 at 0.084 g/m², cellulose acetate propionate binder at 0.24 g/m², polyester sebacate (Paraplex G-25) at 0.044 g/m², and divinyl benzene beads at 0.0034 g/m², coated from a solvent mixture containing 70% toluene, 20% methanol, and 5% cyclopentanone.

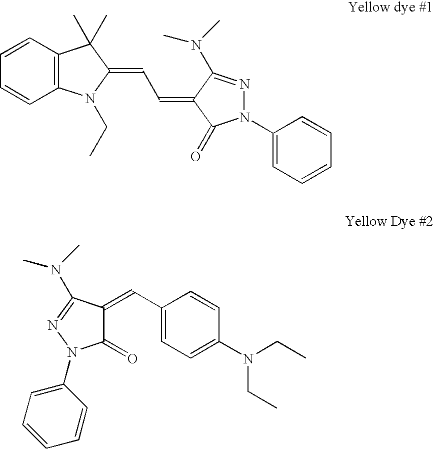

The magenta dye patch contained magenta dye #1 at 0.07 g/m2, magenta dye #2 at 0.14 g/m², and magenta dye #3 illustrated below at 0.016 g/m², cellulose acetate propionate binder at 0.29 μm², polyester sebacate (Paraplex G-25) at 0.05 g/m², and divinyl benzene beads at 0.005 g/m², coated from a solvent mixture containing 70% toluene, 20% methanol, and 5% cyclopentanone.

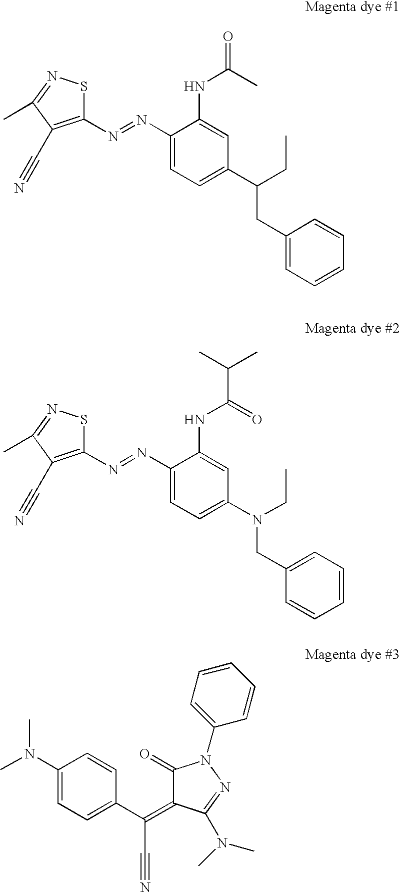

On the reverse side a slipping layer was prepared by coating the following layers in the order recited on 4.5 micron poly(ethylene terephthalate) support. First a subbing layer of a titanium alkoxide (DuPont Tyzor TBT®) (0.12 g/m2) was coated from n-propyl acetate and n-butyl alcohol solvent mixture, then a slipping layer containing an aminopropyl-dimethyl-terminated polydimethylsiloxane, PS513® (United Chemical Technologies) (0.01 g/m²), a poly(vinyl acetal) binder (0.36 g/m²) (Sekisui KS-1), p-toluenesulfonic acid (0.0003 g/m²), candellila wax (0.02 g/m²), and polymethylsisqiloxane (0.05 g/m²), was coated from a solvent mixture of diethylketone, methanol and distilled water (86.5/11.5/2).

Procedure:

The dye-donor element and receiver element were subjected to thermal printing using a Kodak 8670 PS printer. An 1′-step patch image of optical density (OD) ranging from Dₘᵢₙ (OD<0.2) to Dₘₐₓ (OD>2.0) was printed for donor-receiver sticking performance evaluation. The results are shown in Table 2 below.

TABLE 2

| | | Additive | |
|---|---|---|---|
| Sample | Additive | g/m² | Sticking |
| C-1 | None | 0 | yes |
| C-2 | Gelest DMS S-12 | 0.022 | yes |
| C-3 | Gelest DMS S-21 | 0.022 | yes |
| C-4 | GP-10-100 | 0.022 | yes |
| C-5 | GP-10-350 | 0.022 | yes |
| C-6 | GP-10-1000 | 0.022 | yes |
| C-7 | GP-10-10,000 | 0.044 | yes |
| C-8 | GP-360 | 0.044 | yes |
| C-9 | GP-368 | 0.044 | yes |
| C-10 | PECOSIL FSL-150 | 0.11 | yes |
| C-11 | PECOSIL FSL-300 | 0.11 | yes |
| C-12 | PECOSIL FSH-150 | 0.11 | yes |
| E-1 | GP-7101 | 0.044 | no |
| E-2 | GP-7101 | 0.022 | no |
| E-3 | GP-7105 | 0.044 | no |
| E-4 | GP-70S | 0.022 | no |
| E-5 | GP-70S | 0.011 | no |
| E-6 | GP-70S | 0.004 | no |
| E-7 | GP-70S | 0.001 | no |
| E-8 | GP-74 | 0.004 | no |
| E-9 | GP-74 | 0.001 | no |
| E-10 | GP-154 | 0.011 | no |
| E-11 | GP-154 | 0.001 | no |

Table 2 shows that stick preventative agents as described herein of modified polydimethyl siloxanes, such as (1) polydimethyl silicones with an organic wax side chain (E-1, E-2), (2) a polydimethyl silicone with an amine functionalized organic wax side chain (E-3), and (3) methylalkylaryl silicones (E-4 to E-11), demonstrate no donor-receiver sticking, while the comparative examples without a release agent (C-1), or with known release agents such as (a) polydimethyl siloxanes of varied molecular weight (C-2 to C-7), (b) modified polydimethyl siloxanes such as methyloctyl (C-9) and dimethyl/methyloctyl (C-8) silicone copolymers, and (c) fluorosilicones of varied fluoro-content (C-10, C-1, C-12), show undesirable donor-receiver sticking.

### Example 2

### Solvent-Coated Dye Image-Receiving Layer

The dye-donor element and receiver element were prepared as in Example 1, with the receiver elements containing stick preventative agents or release agents as shown in Table 3.

TABLE 3

| | | Additive | |
|---|---|---|---|
| Sample | Additive | (g/m²) | Sticking |
| C-13 | Silwet L-7230 | 0.001 | yes |
| C-14 | Silwet L-7230 | 0.002 | yes |
| C-15 | Silwet L-7230 | 0.011 | yes (slight) |
| E-7 | GP-70S | 0.001 | no |
| E-9 | GP-74 | 0.001 | no |
| E-11 | GP-154 | 0.001 | no |

As shown in Table 3, the stick preventative agents as set forth herein provide excellent donor-receiver sticking resistance, even at very low concentrations (see E-7, E-9, and E-11), while the comparative release agents show sticking at similar, and even higher, concentrations (see C-13, C-14, and C-15).

### Example 3

### Extruded Dye Image-Receiving Layer

Dye image-receiving layers having the compositions shown in Table 4 were prepared both by solvent coating as described in Example 1, and by extrusion coating as set forth below. All compounds set forth in Table 4 are in percent by weight of the dye image-receiving layer. The dye-donor element was prepared as in Example 1.

TABLE 4

| Sample | Additive | MB50-315 | GP-X | PES | PC | DOS | H₃PO₃ |
|---|---|---|---|---|---|---|---|
| C-16 | none | 0 | 0 | 74.64 | 20.01 | 5.33 | 0.02 |
| C-17 | MB50-315 | 3 | 0 | 73.46 | 18.19 | 5.33 | 0.02 |
| C-18 | MB50-315 | 12 | 0 | 69.61 | 12.74 | 5.33 | 0.02 |
| C-19 | GP-7101 | 0 | 1.21 | 73.69 | 19.76 | 5.33 | 0.02 |
| C-20 | GP-7105 | 0 | 1.21 | 73.69 | 19.76 | 5.33 | 0.02 |
| E-12 | GP-70S | 3 | 1.2 | 72.5 | 17.94 | 5.33 | 0.03 |
| E-13 | GP-70S | 3 | 0.8 | 72.8 | 18.05 | 5.33 | 0.02 |
| E-14 | GP-70S | 3 | 0.4 | 73.14 | 18.11 | 5.33 | 0.02 |
| E-15 | GP-70S | 0 | 1.2 | 73.69 | 19.76 | 5.33 | 0.02 |
| E-16 | GP-70S | 0 | 0.6 | 74.17 | 19.88 | 5.33 | 0.02 |
| E-17 | GP-74 | 0 | 0.6 | 74.17 | 19.88 | 5.33 | 0.02 |

Receiver Element:

Dye image-receiving layers according to the compositions set forth in Table 4 were made by the following method:

PES was dried in a NOVATECH desiccant dryer at 43° C. for 24 hours. The dryer was equipped with a secondary heat exchanger so that the temperature did not exceed 43° C. during the time the desiccant was recharged. The dew point was −40° C.

LEXAN 151 polycarbonate from General Electric Co., and MB50-315 silicone (a blend of bisphenol-A polycarbonate and ultrahigh MW polydimethyl siloxane at a 50:50 blend ratio) from Dow Chemical Co. as needed according to Table 4, were mixed in a ratio based on the percent compositions stated in Table 4, and dried at 120° C. for 2-4 hours at −40° C. dew point.

Dioctyl Sebecate ('DOS) was preheated to 83° C., and then phosphorous acid was added after heating, in amounts according to Table 4. If required by the formulation, additives according to Table 4 were added to the heated dioctyl sebecate/phosphorous acid solution except for MB50-315, which was added elsewhere. This mixture was maintained at 83° C. and mixed for 1 hour under nitrogen before use.

Each of the dye image-receiving materials according to Table 4 was subjected to a compounding operation. The compounding was done in a LEISTRITZ ZSK 27 extruder with a 30:1 length to diameter ratio. The LEXAN-polycarbonate/MB50-315-silicone material was introduced into the compounder first, and melted. The heated dioctyl sebecate/phosphorous acid solution was added, and the PES was added last. A vacuum of slightly negative pressure was then applied to the mixture, and a temperature of 240° C. was maintained. The melted mixture was extruded through a strand die, cooled in 32° C. water, and pelletized. The pelletized dye image-receiving layer material was aged for about two weeks. After the two weeks, the pellets were predried at 38° C. for 24 hours in a NOVATECH dryer, under the conditions described above. The dried pellets were conveyed to an extruder (described below) using desiccated air.

The dye image-receiving layer pellets were introduced into a liquid cooled hopper feeding a 6.3 cm single screw BLACK CLAWSON extruder having a 6.3 cm long cooling section in the beginning of the extruder, cooled by 20° C. water. The screw was a standard compression screw with a single mixer. The pellets were melted in the extruder by heating to a temperature of 238° C. The pressure was increased through a melt pump, and the melted composition was pumped to a CLEOREN coextrusion feedblock with AAABB configuration.

A tie-layer was also compounded. PELESTAT 300 antistatic polymer from Sanyo Chemical Co. was predried as described above in the NOVATECH dryer at 77° C. for 24 hours. After drying, the polymer was melt-mixed in the LEISTRITZ ZSK 27 extruder with undried HUNTSMAN P4G2Z-159 polypropylene homopolymer in a 70/30 ratio at about 240° C., then forced through a strand die into 20° C. water and pelletized. The compounded tie-layer pellets were dried again at 77° C. for 24 hours in a NOVATECH dryer, and conveyed by desiccated air to the extruder.

The tie-layer pellets were introduced into a liquid cooled hopper of a second 6.3 cm single screw extruder as described above. The tie-layer pellets were heated to 238° C., and pumped to the CLEOREN coextrusion feedblock.

The volumetric ratio of dye image-receiving layer material to tie-layer material was about 3:1. The dye image-receiving layer material and the tie-layer material were brought into intimate contact in the CLOEREN feedblock, and passed to a standard extrusion coating T-die made by Cloeren, having a slot of 0.8 mm, and a land length of 2.5 mm. The die formed a melt curtain traveling 19 cm through the air before being coated onto the laminate support comprising a paper core extrusion laminated with a 38 μm thick microvoided composite film (OPPalyte® 350TW, Mobile Chemical Co., disclosed in U.S. Pat. No. 5,244,861).

The melt curtain was immediately quenched in a nip between a chill roll and the laminate support. The chill roll was operated at 21° C. The thickness of the coated die image-receiving layer was 3 μm, and the thickness of the coated tie-layer was 1 μm. The resultant coated paper was wound onto a roll and converted to the necessary dimensions for the thermal printing operation.

The dye-donor element and receiver element (solvent and extrusion coated) were subjected to thermal printing as in Example 1. The results are shown in Table 5 below.

TABLE 5

| | Solvent ctg. | | Extrusion ctg. |
|---|---|---|---|
| Sample | Sticking* | Melt stability | Sticking* |
| C-16 | 5 | good | 5 |
| C-17 | poor ctg. | good | 4 |
| C-18 | poor ctg. | good | 3 |
| C-19 | 1 | reactive | na |
| C-20 | 1 | reactive | na |
| E-12 | poor ctg. | good | 1 |
| E-13 | poor ctg. | good | 1 |
| E-14 | poor ctg. | good | 2 |
| E-15 | 1 | good | 2 |
| E-16 | 1 | good | 3 |
| E-17 | 1 | good | 1 |

*numerical ranking 1-5: 1 = best performance; 5 = worst

Comparative Examples C-19 and C-20, though containing stick preventative agents of the invention, are shown in Table 5 as “comparative” examples because they are unsuitable for melt extrusion. While not wishing to be bound by theory, the stick preventative agents of C-19 and C-20 are thought to be reactive with the dye image-receiving layer materials at extrusion temperatures (240-270° C.), increasing the melt viscosity of the composition due to multiple chemical reactions and resulting in a non-extrudable state. When solvent coated, excellent results were obtained.

Use of release agent MB50-315 progressively reduced donor-receiver sticking in extruded coatings, as seen in comparative examples C-16, C-17, and C-18, although the addition of MB50-315 made poor solvent coatings (C-16, C-17). Use of MB50-315 in combination with stick preventative agents (E-12, E-13, and E-14) also caused problems in solvent coating, though good extrusion coatings with excellent donor-receiver sticking properties were obtained.

Use of stick preventative agent alone, as shown in examples E-15, E-16, and E-17, resulted in excellent solvent coating and good extrusion coating donor-receiver sticking properties without effecting coatability, and with use of less additive material (see E-16 and E-17 with 0.6% by weight stick preventative agent), as compared to other release agents alone or in combination with the stick preventative agents.

The invention has been described in detail with particular reference to preferred embodiments thereof, but it will be understood that variations and modifications can be effected within the spirit and scope of the invention.

1. A thermal receiver element comprising a dye image-receiving layer, wherein the receiver element includes a stick preventative agent of the formula: 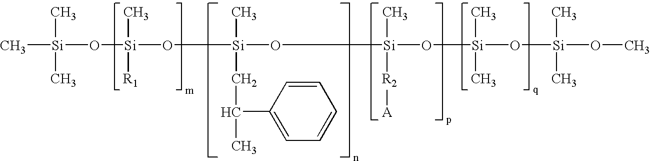
wherein R₁ is an alkyl chain of C₉H₁₉ or greater; R₂ is an alkyl chain Of C₃H₆ or greater; A is NH—R₃, NHNH₂, NHCO—R₃, NH—R₄—NH₂, or NHCO—R₄—NH₂; R₃ is an alkyl chain of C₂H₅ or greater; R₄ is an alkyl chain of C₂H₄ or greater; m is from about 0 to 95 weight percent; n is from about 0 to about 70 weight percent; p is from 0 to about 40 weight percent; and q is from 0 to 95 weight percent, with the proviso that when m is 0, then n is 0, and R₃ is an alkyl chain of C₈H₁₇ or greater, otherwise when m is greater than 0, n is from 0.1 to 70 weight percent, based on the total weight of the stick preventative agent.

2. The thermal receiver element of claim 1, wherein the stick preventative agent is in the dye image-receiving layer.

3. The thermal receiver element of claim 2, wherein the dye image-receiving layer is extrusion coated on a support, and the stick preventative agent has the formula wherein p is 0.

4. The thermal receiver element of claim 1, wherein the receiver further comprises a support including the stick preventative agent.

5. The thermal receiver element of claim 1, wherein the stick preventative agent is present in an amount greater than or equal to 5.5×10⁻⁴ g/m².

6. The thermal receiver element of claim 1, wherein the stick preventative agent is present in an amount of from about 5.5×10⁻⁴ g/m² to about 0.022 g/m².

7. The thermal receiver element of claim 1, further comprising a release agent.

8. The thermal receiver element of claim 7, wherein the release agent is a solid polydimethylsiloxane.

9. The thermal receiver element of claim 8, wherein the release agent is a blend of bisphenol-A polycarbonate and polydimethyl siloxane.

10. A print assembly comprising a dye-donor element including a dye-donor layer, and a receiver element of claim 1, wherein the dye-donor element and receiver element are in superposed position such that the dye-donor layer is adjacent the dye image-receiving layer.

11. The print assembly of claim 10, wherein the stick preventative agent is in the dye image-receiving layer.

12. The print assembly of claim 11, wherein the dye image-receiving layer is extrusion coated, and the stick preventative agent has the formula wherein p is 0.

13. A method of forming an image, comprising:
forming the print assembly of claim 10;
positioning the dye-donor element of the print assembly adjacent a thermal print head;
imagewise heating the thermal print head, transferring dye from the dye-donor layer to the receiver element to form an image on the receiver element; and
separating the dye-donor element and receiver element to expose the image.

14. The method of claim 13, further comprising:
forming the dye-donor element having the dye-donor layer;
forming the receiver element having the dye image-receiving layer; and
placing the dye-donor element and receiver in superposed position such that the dye-donor layer is adjacent the dye image-receiving layer.

15. The method of claim 14, wherein forming the receiver element comprises extrusion coating the dye image-receiving layer including the stick preventative agent on a support, wherein the stick preventative agent has the formula wherein p is 0.

16. The method of claim 13, wherein the image has a density of at least 1.5.

17. The thermal receiver element of claim 2, wherein the stick preventative agent has the formula wherein m and n are both 0.

18. The thermal receiver element of claim 2, wherein the stick preventative agent has the formula wherein p is 0.
